(19) United States
(12) Patent Application Publication
(10) Pub. No.: US 2012/0260749 A1
(43) Pub. Date: Oct. 18, 2012

(54) TEST DEVICE

(75) Inventors: XIAN-BO FAN, Shenzhen City (CN); YOU-XI WEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/103,826

(22) Filed: May 9, 2011

(30) Foreign Application Priority Data
Apr. 13, 2011 (CN) 201110091504.5

(51) Int. Cl. G01N 19/00

(52) U.S. Cl. 73/865.3

(57) ABSTRACT

A test device is used for testing stability of products. The test device includes a holder, a motor mounted on the holder and a supporting board mounted on the motor. The supporting board includes a supporting surface for supporting the products being tested. The supporting board connects to the motor. The motor drives the supporting board to rotate.

### BACKGROUND

1. Technical Field

The present disclosure relates to test devices and, more particularly, to a device that can test the ability of products to remain upright on a tilted supporting surface.

2. Description of Related Art

Conventionally, when testing the stability of a newly designed product, the product is placed on a flat surface, and the product is tilted to different positions to test the stability of the product. However, it needs to manually adjust the products to different positions, and this process is time consuming and laborious, which results in a low testing efficiency.

Therefore, what is needed is a test device, which can overcome the above described shortcomings

### BRIEF DESCRIPTION OF THE DRAWINGS

FIG. 1 is an assembled, isometric view of a test device in accordance with a first embodiment of the present disclosure.

FIG. 2 is the test device of FIG. 1 in an operational state.

FIG. 3 is an assembled, isometric view of a test device in accordance with a second embodiment of the present disclosure.

### DETAILED DESCRIPTION

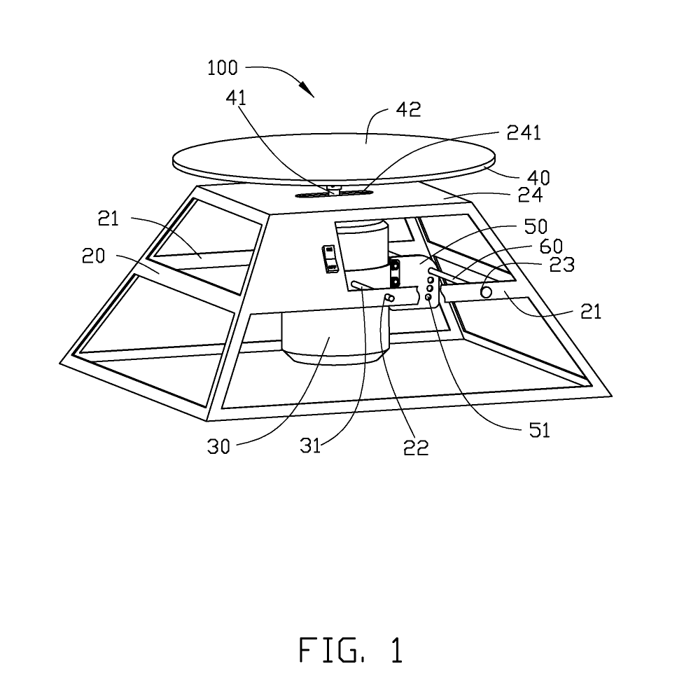

Referring to FIG. 1, a test device 100, in accordance with a first embodiment, includes a holder 20, a motor 30 mounted on the holder 20, a supporting board 40 mounted on the motor 30, and an adjusting board 50 and a first shaft 60 fixed on the motor 30.

In the present embodiment, the holder 20 includes two bars 21 arranged at two opposite sides thereof. Each bar 21 defines a through hole 22 and a first mounting hole 23. In alternative embodiment, the first mounting hole 23 can be two or more than two. The holder 20 includes an upper body 24 defining a slot 241 at a center portion thereof.

The motor 30 has a second shaft 31 engaged with the holder 20, therefore, the motor 30 can rotate relative to the second shaft 31. In the present embodiment, the motor 30 is a stepper motor.

The supporting board 40 is fixed on the motor 30 by a pole 41. One end of the pole 41 is fixed on the motor 30, and the other end of the pole 41 extends through the slot 241 of the upper body 24 and connects to the supporting board 40. The supporting board 40 is planar. The supporting board 40 defines a supporting surface 42 at an upper portion to support products being tested. The pole 41 is perpendicular to the supporting surface 42. When the motor 30 rotates about the second shaft 31, the supporting board 40 will be tilted accordingly.

The adjusting board 50 is fixed on the motor 30. In the present embodiment, the adjusting board 50 is planar, and perpendicular to the second shaft 31. The adjusting board 50 defines four spaced second mounting holes 51 in an array at one side away from the motor 30. In alternative embodiments, the second mounting holes 51 can be two, three, or more than four.

The first shaft 60 extends through one of the second mounting holes 51 with opposite ends engaged in the first mounting holes 23 to fix the adjusting board 50 on the holder 20. As shown in FIG. 1, the first shaft 60 extends through the uppermost second mounting hole 51, and the supporting surface 42 is horizontal. The motor 30 can rotate the supporting board 40 360 degrees and test the stability of products while supported on a horizontal surface.

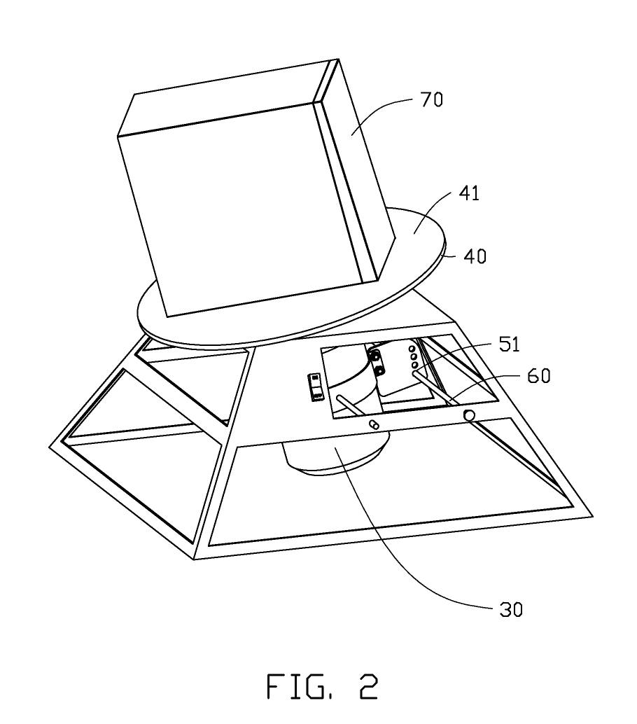

Referring to FIG. 2, the first shaft 60 is adjusted to extend through the bottommost second mounting hole 51 of the adjusting board 50, therefore, the supporting surface 42 of the supporting board 40 is tilted to a predetermined angle. A product 70 is arranged on the supporting surface 42, and the motor 30 rotates the supporting board 40 360 degrees to test the stability of a product 70 supported on a tilted surface. It can be understood that the first shaft 60 can extend through different second mounting holes 51 of the adjusting board 50 to change the tilt angle of the motor 30 and the supporting surface 42, to test stability of the product 70 supported on surfaces tilted to different predetermined angles

It can be understood that the number and the position of the mounting holes 51 can be changed according to need. Each mounting hole 51 corresponds to a predetermined angle of tilt of the supporting board 40, and labels corresponding to the degree of tilt achieved with each mounting hole 51 can be applied near the holes 51.

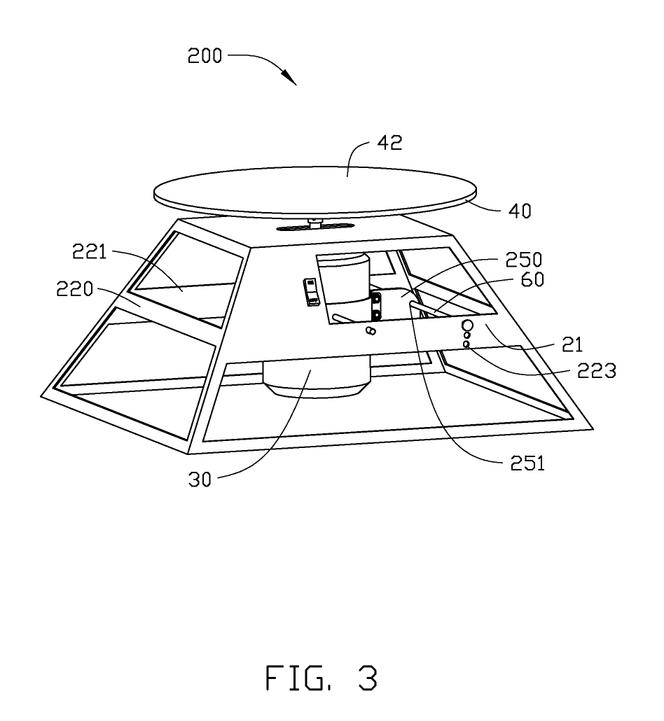

Referring to FIG. 3, a test device 200 according to a second embodiment is shown. Differing from the test device 100 of the first embodiment, each bar 221 of the holder 220 defines a plurality of first mounting holes 223 arranged in an array along a vertical direction and spaced from each other, and the adjusting board 250 defines a second mounting hole 251. The first shaft 60 extends through the second mounting hole 251 of the adjusting board 250 and different first mounting holes 223 of the holder 220 to adjust the obliquity of the motor 30, therefore, the obliquity of the supporting surface 42 of the supporting board 40 is adjusted. It can be understood that the adjusting board 250 can be also defines a plurality of second mounting holes 251, and the first shaft 60 can extend through different first and second mounting holes 223, 251 to adjust the obliquity of the supporting surface 42 of the supporting board 40.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A test device for testing stability of products, comprising:
a holder;
a motor mounted on the holder; and
a supporting board defining a supporting surface for retaining the products, the supporting board being connected to the motor and being driven to rotate by the motor.

2. The test device of claim 1, wherein the motor pivotally engages with the holder, the test device further comprising an adjusting board and a first shaft, the adjusting board being fixed on the motor, the first shaft extending through the adjusting board to fix the adjusting board on the holder.

3. The test device of claim 2, wherein the adjusting board defines a plurality of mounting holes, the first shaft extending through different mounting holes to adjust the obliquity of the supporting board.

4. The test device of claim 3, wherein the mounting holes is arranged in an array and spaced from each other.

5. The test device of claim 2, wherein the holder defines a plurality of first mounting holes and the adjust board defines a second mounting hole, the first shaft extending through different first mounting holes and the second mounting hole to adjust the obliquity of the supporting board.

6. The test device of claim 5, wherein the second mounting hole is arranged in an array and spaced from each other.

7. The test device of claim 2, wherein the supporting board is fixed on the motor by a pole, the pole being perpendicular to the supporting surface of the supporting board.

8. The test device of claim 1, wherein the holder includes an upper body defining a slot, the supporting board is fixed on the motor by a pole extending through the slot.

9. A test device for testing stability of products, comprising:
a holder;
a supporting board defining a supporting surface at an upper portion for retaining the products;
an adjusting board connected to the supporting board; and
a first shaft extending through the adjusting board to make the supporting board fix on the holder and adjust the obliquity of the supporting board.

10. The test device of claim 9, further comprising a motor mounted on the holder, the supporting board and the adjusting board being fixed on the motor and being driven to rotate by the motor, the first shaft extending through the adjusting board to make the motor fix on the holder and adjust the obliquity of the supporting board.

11. The test device of claim 10, wherein the motor pivotally engages with the holder.

12. The test device of claim 9, wherein the adjusting board defines a plurality of mounting holes, the first shaft extending through different mounting holes to adjust the obliquity of the supporting board.

13. The test device of claim 12, wherein the mounting holes is arranged in an array and spaced from each other.

14. The test device of claim 9, wherein the holder defines a plurality of first mounting holes and the adjust board defines a second mounting hole, the first shaft extending through different first mounting holes and the second mounting hole to adjust the obliquity of the supporting board.

15. The test device of claim 14, wherein the second mounting hole is arranged in an array and spaced from each other.
